(19) United States
(12) Patent Application Publication
(10) Pub. No.: US 2003/0078803 A1
(43) Pub. Date: Apr. 24, 2003

(54) System and method for distribution of computational tasks related to a stimulus received by a consumer product

(76) Inventor: Haipeng Xie, Scarborough (CA)

Correspondence Address: SIMON, GALASSO & FRANTZ PLC., P.O. Box 26503, Austin, TX, 78755-0503, US

(21) Appl. No.: 10/273,766

(22) Filed: Oct. 18, 2002

Related U.S. Application Data
(60) Provisional application No. 60/347,681, filed on Oct. 23, 2001.

(51) Int. Cl. G06F 17/60

(52) U.S. Cl. 705/1

(57) ABSTRACT

A system and method for distributing computational tasks resulting from the receipt of a stimulus by a consumer product are disclosed herein. The consumer product receives a stimulus, such as a user entering data or a signal from an internal timer, and generates a representation of the stimulus and transmits the stimulus representation to a remote computing device. The stimulus representation can include data representing the stimulus, associated data, and data representing a desired action or a computational task to be performed. The remote computing device generates a response as a result of the processing of the included computational task or development of the desired action and transmits a representation of the desired response to the consumer product. The consumer product can then incorporate the response, such as by displaying the result, performing an action dictated by the response, and the like. By directing the remote computing device to process the computational task or generate the desired action resulting from the receipt of the stimulus, the consumer product can make use of the relatively superior processing capability, power supply, and/or communications system of the remote computing device, while the consumer product provides a low cost and/or portable means to respond to the stimulus.

### CROSS REFERENCE TO RELATED APPLICATIONS

This application claims the benefit of U.S. Provisional Patent Application Serial No. 60/347,681, filed Oct. 23, 2001, entitled “System And Method For Distribution Of Computational Tasks Related To A Simulus Received By A Consumer Product,” of common assignee herewith.

### FIELD OF THE DISCLOSURE

The present disclosure relates generally to distribution of computational tasks and more particularly to distribution of a computational task from a consumer product to a remote computing device.

### BACKGROUND

Various systems have been developed to exhibit various levels of simulated intelligence. For example, the National Aeronautics and Space Administration (NASA) has a number of planetary explorers, such as the Mars Lander, that are semi-autonomous but request direction when certain situations are encountered, such as rocks in the path of the Mars Lander. Likewise, sophisticated concept devices, have been developed to rely on other devices for assistance with certain actions or computational tasks. For example, a robot has been developed to. However, these “intelligent” systems often implement relatively advanced components, such as advanced data processors, advanced communications systems, and complicated mechanical and electrical assemblies used to perform a directed action. The use of these advanced components often significantly increases the cost of these systems, preventing their purchase by the average consumer. Likewise, many of these intelligent systems, such as the Mars Lander, are custom-made, further increasing the cost of production of the intelligent system since producers of custom-made devices generally cannot make use of the economies of scale.

Given the limitations, as discussed, it is apparent that conventional intelligent systems are less than perfect.

### BRIEF DESCRIPTION OF THE DRAWINGS

Various display objects, advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of this specification.

FIG. 1 is a block diagram illustrating a distributed system according to at least one embodiment of the present disclosure;

FIG. 2 is a block diagram illustrating a remote computing device according to at least one embodiment of the present disclosure;

FIG. 3 is a block diagram illustrating a consumer product according to at least one embodiment of the present disclosure;

FIG. 4 is a flow diagram illustrating a method for distributed computing according to at least one embodiment of the present disclosure; and

FIG. 5 is a block diagram illustrating an exemplary implementation of the distributed computing system illustrated in FIG. 1 according to at least one embodiment of the present disclosure.

### DETAILED DESCRIPTION OF THE FIGURES

In accordance with at least one embodiment of the present disclosure, a representation of a first stimulus from a consumer product is received at a remote computing device, wherein the representation of the first stimulus is generated by the consumer product in response to the first stimulus, and where the remote computing device is remote relative to the animated consumer product. A desired response is determined at the remote computing device based on the representation of the first stimulus and a representation of the desired response is transmitted for reception by the consumer product. One advantage in accordance with a specific embodiment of the present disclosure is that less expense is incurred than with a conventional consumer product. Another advantage is that less power is consumed compared to conventional consumer products.

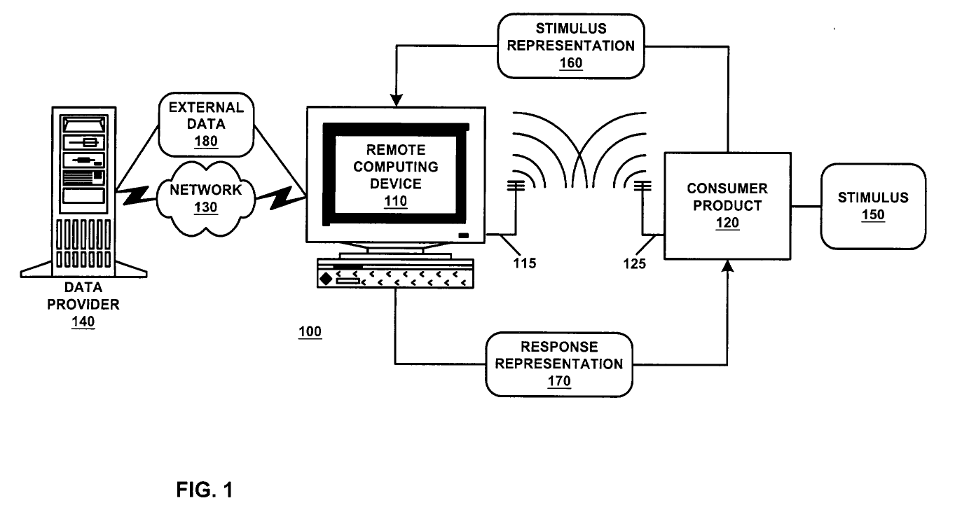

FIGS. 1-5 illustrate a system and method for distributing computational tasks resulting from the receipt of a stimulus by a consumer product. In at least one embodiment, the consumer product receives a stimulus, such as a user entering data, a signal from an internal timer or sensor signal from external environment such as sound and video, and generates a representation of the stimulus and transmits the stimulus representation to a remote computing device if the local processing unit is not capable or not defined to process the stimulus. The stimulus representation, in one embodiment, includes data representing the stimulus, associated data, and data representing a desired action or a computational task to be performed. The remote computing device generates a response as a result of the processing of the included computational task or development of the desired action and transmits a representation of the desired response to the consumer product. The consumer product can then incorporate the response, such as by displaying the result, performing an action dictated by the response, and the like. By directing the remote computing device to process the computational task or generate the desired action resulting from the receipt of the stimulus, the consumer product can make use of the relatively superior processing capability, power supply, and/or communications system of the remote computing device, while the consumer product provides a low cost and/or portable means to respond to the stimulus.

Referring now to FIG. 1, a system for the distribution of a computational workload between a consumer product and a remote computing device is illustrated according to at least one embodiment of the present disclosure. In at least one embodiment, the system, herein referred to as distributed system 100, allows a consumer product having limited resources to make use of the superior resources of the remote computing device to perform computational tasks, perform communication services, and the like. Distributed system 100 includes remote computing device 110 and consumer product 120. Remote computing device 110, in at least one embodiment, includes a consumer-level information handling system, such as a personal computer (PC), notebook computer, handheld computing device, cellular phone, and the like. Consumer product 120 can include one of a variety of consumer products having a limited data processing capability and/or a limited operating instruction set. The term “consumer product”, as used herein, refers to a mass-market consumer product, where the consumer product is targeted to, and affordable by, a large portion of a significant segment of society. Similarly, the term “consumer product” can include mass-produced products available for purchase at common retail establishments. For example, in one embodiment, consumer product 120 includes an entertainment-based consumer product, such as an animated toy, available at the stores of a nation-wide toy store chain. In another embodiment, consumer product 120 includes a home-electronics consumer products, such as a camera or a compact disc (CD) player, stocked by an electronics superstore.

Remote computing device 110 and consumer product 120 communicate using host interface 115 and mobile interface 125, respectively. Interfaces 115-125 can include wireless interfaces, such as radio frequency (RF) transceivers, microwave transceivers, infrared transceivers, and the like. Likewise, interfaces 115-125 can include physical interfaces, RS- 232 serial bus, a parallel bus, a universal serial bus (USB), and the like. In at least one embodiment, remote computing device 110 is remotely located relative to consumer product 120. For example, remote computing device 110 can be located a large geographical distance from consumer product 120 but still be connected via a network, such as the Internet. Alternatively, remote computing device 110 can be located relatively close to consumer product 120 and connected via a wireless interface, such as via RF transceivers.

In at least one embodiment, distributed system 100 further includes data provider 140 connected to remote computing device 110 via network 130. Data provider 140 can include one or more data servers that provide remote computing device 110 with requested data, while network 130 can include a variety of networks, such as a local area network (LAN), a wide area network (WAN), the Internet, and the like. For example, data provider 140 can include an Internet or data server connected to remote computing device 110 over the Internet (network 130).

In at least one embodiment of the present disclosure, consumer product 120 receives stimulus 150. Stimulus 150, in one embodiment, includes a stimulus external to consumer product 120, such as a user hitting a button on consumer product 120. The external stimulus can also include an environmental stimulus, such as a light or sound stimulus, a stimulus caused by consumer product 120 coming in contact with an object within its environment, a thermal stimulus, and the like. Alternatively, stimulus 150 can include a stimulus internal to consumer product 120, such as a signal from a timer that has counted down to zero, a counter reaching a certain value, an interrupt request transmitted by a peripheral device of consumer product 120, and/or the detection of a certain value or type of data being processed by consumer product 120.

In one embodiment, consumer product 120 determines if a response to stimulus 150 is available local to consumer product 120. For example, consumer product 120 can include a calculator having a limited set of operating instructions and stimulus 150 could include a request to solve a differential equation. In this case, the calculator (consumer product 120) could determine if a differential equation solving algorithm is available within its local set of operating instructions. Likewise, in at least one embodiment, consumer product 120 determines if it can effectively carry out any determined response to stimulus 150. Factors that determine the effectiveness can include, but are not limited to, the amount of power consumed while performing the response, the speed at which the response can be performed (i.e. processing power or communications bandwidth), the necessary functions, and the like. Using the previous example of a calculator, the calculator could lack the processing power to speedily solve the differential equation. Similarly, solving the differential equation could incur an unacceptable drain on the batteries of the calculator, and so on. In the event that a local response to stimulus 150 is available or feasible, consumer product 120 can perform the local response. If not, in one embodiment, a desired response to stimulus 150 can be obtained from remote computing device 110.

Accordingly, in at least one embodiment, consumer product 120 generates stimulus representation 160 and transmits it to remote computing device 110 for consideration. The transmission of stimulus representation 160, in one embodiment, is performed using host interface 115 and mobile interface 125. For example, interfaces 115-125 can include low-power RF interfaces that allow consumer product 120 and remote computing device 110 to communicate over short distances. Stimulus representation 160 can include a representation of stimulus 150 in a form appropriate to remote computing device 110 and any other necessary parameters needed by remote computing device 110 to adequately define stimulus 150. Using the previous calculator example, stimulus representation 160 could include data representative of the differential equation to be solved and a descriptor that describes the architecture or instruction set of the calculator's processor.

Remote computing device 110, in at least one embodiment, receives stimulus representation 160 and generates a response (not shown) to stimulus 150 to be implemented by consumer product 120. The response can include a computational task, instructions, data, and/or information to be performed, displayed, and/or manipulated by consumer product 120. Using the previous calculator example, the generated response could include the solution to the differential equation problem. The response, in this case, could also include bitmap data used by consumer product 120 to graphically display a plot of the differential equation's solution. The response, in one embodiment, is transmitted to consumer product 120 using interfaces 115-125 in the form of response representation 170. Response representation 170 includes the response in a format appropriate to consumer product 120, such as a format defined by a processor architecture of consumer product 120.

In at least one embodiment, remote computing device 110 generates response representation 170 based on a history of stimulus representations 160. For example, consumer product 120 can include a toy that navigates on a floor, where the toy includes a contact sensor that triggers a bump stimulus (one embodiment of stimulus 150) every time it encounters an object on the floor. In this case, the toy can include a limited set of operating instructions that direct the toy to back up and turn to the left a certain distance each time a bump stimulus is generated. Additionally, each time a bump stimulus is generated, the toy transmits stimulus representation 160 to remote computing device 110 signifying that it encountered an object and remote computing device 110 logs the stimulus representations 160 sent by the toy. Remote computing device 110 can then examine a history or log of bump stimuli received by the toy to determine the appropriate response for the toy to perform. For example, if the toy received a certain number of bump stimuli in a row, then remote computing device 110 could determine that the toy is surrounded by objects and direct the toy to shutdown for a certain number of seconds by transmitting response representation 170 to the toy. Alternatively, remote computing device 110 can transmit an updated set of operating instructions to the toy as response representation 170, where the updated set of operating instructions direct the toy to respond in a different manner to a bump stimulus than before.

Rather than determining the desired response based solely on stimulus representation 160, remote computing device 110, in one embodiment, uses user input in addition to stimulus representation 160 to determine the desired response. Using the previous navigating toy example, remote computing device 110 can display a message on a monitor of remote computing device 110 for viewing by a user after a certain number of bump stimuli. For example, the message could display a map illustrating the locations where the toy bumped into an object. In this case, the user could determine a path for the toy to follow and input this path to remote computing device 110. Remote computing device 110 can then transform the path (the response) input by the user into a set of operating instructions to be performed by the toy and then send the set of operating instructions to the toy as response representation 170.

In at least one embodiment, external data 180 from data provider 140 is utilized by remote computing device 110 to generate the response. External data 180 can include information that is locally unavailable to remote computing device 110. For example, consumer product 120 can include a compact disc (CD) player that has been directed to play a certain CD (stimulus 150). In this case, stimulus representation 160 can include file, such as an Moving Picture Experts Group Layer-3 (MP3) file, representing a music track from the CD as well as a request to have remote computing device 110 analyze the lyrics of the musical track for profane words. In this case, certain words in the lyrics could be absent from a dictionary database local to remote computing device 110, so remote computing device 110 could send a request for the definition of a potential profane word through the Internet (one embodiment of network 130) to a dictionary database (one embodiment of data provider 140). The dictionary database could return external data 180, where external data 180 includes a value indicating whether the submitted word is considered profane. Remote computing device 110 can then transmit a value indicating the presence or lack thereof of profanity within the lyrics of the musical track as response representation 170.

Although distributed system 100 has been illustrated in FIG. 1 as a single remote computing device 110 associated with a single consumer product 120, in at least one embodiment, remote computing device 110 manages a plurality of consumer products 120. For example, distributed system 100 can include a home theatre system having a receiver, a DVD player, and a television (all examples of consumer product 120), where the elements of the home theatre system are connected to a personal computer (remote computing device 110) via a wireless interface. In this case, the personal computer could receive information about a DVD to be played by the DVD player to determine settings for the receiver and the television, such as volume, treble and bass settings, and the like. As demonstrated, remote computing device 110 can be used to generate a plurality of responses for a plurality of consumer products 120 so that the plurality of consumer products 120 operate in harmony. Alternatively, remote computing device 110 can generate responses for consumer products 120 independent of other consumer products 120. Likewise, a plurality of remote computing devices 110 can be utilized by consumer product 120 to perform a computational task.

Instead of, or in addition to, assigning a plurality of consumer products 120 to a single remote computing device 110, in one embodiment, one consumer product 120 can make use of a plurality of remote computing devices 110. For example, consumer product 120 can transmit different stimulus representations 160 to different remote computing devices 110 based the capabilities of the remote computing devices. Likewise, consumer product 120 can be assigned to a different remote computing device 110 as the location of consumer product 120 and/or remote computing device 110 changes. For example, consumer product 120 could include child's toy having a wireless transmitter (mobile interface 125) of limited power. Accordingly, as the user of the toy moves about a house, the consumer product 120 could be assigned to the closest computing device in the house.

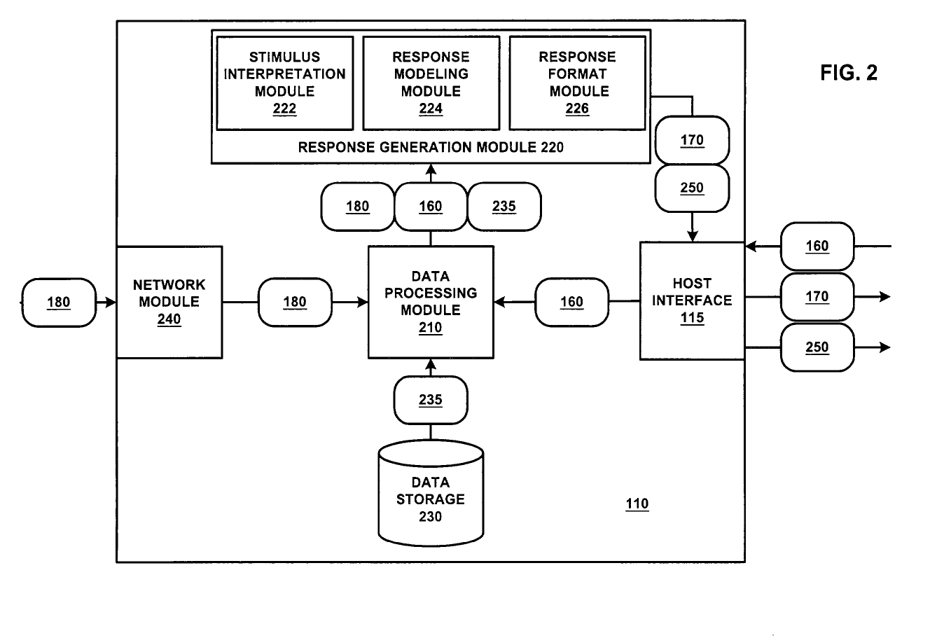

Referring to FIG. 2, remote computing device 110 is illustrated in greater detail according to at least one embodiment of the present disclosure. Remote computing device 110 includes data processing module 210, response generation module 220, data storage 230, network module 240, and host interface 115. As discussed previously, in at least one embodiment, remote computing device 110 receives stimulus representation 160 (FIG. 1), representing stimulus 150 (FIG. 1) received by consumer product 120 (FIG. 1), and generates response representation 170 (FIG. 1) based on stimulus representation 160.

In at least one embodiment, remote computing device 110 receives stimulus representation 160 from consumer product 120 (FIG. 1) via host interface 115. As discussed previously, host interface 115 can include a wireless interface, such as a RF transceiver, or a physical interface, such as a RS-232 serial bus. Host interface 115 receives stimulus representation 160 and provides it to data processing module 210 after any necessary manipulation, such as error checking, stripping a header, and the like. Data processing module 210 can include one of a variety of data processing systems, such as a microprocessor, an application specific integrated circuit (ASIC), a programmable logic device, and the like. For example, remote computing device 110 can be implemented using a personal computer. In this case, data processing module 210 can include the central processing unit (CPU) of the personal computer. Similarly, data processing module 210 can be implemented as a peripheral component of the personal computer, such as a peripheral component interconnect (PCI) card.

Data processing module 210, in one embodiment, passes stimulus representation 160 to response generation module 220. Response generation module 220 can be implemented as a set of executable instructions to be executed by data processing module 210, as a separate hardware component, or a combination thereof. Response generation module 220 includes stimulus representation module 222, product modeling module 224, and response format module 226. Stimulus interpretation module 222, in one embodiment, receives stimulus representation 160 and determines or identifies the desired computational task and/or requested action represented by stimulus representation 160. Using the previous example of consumer product 120 (FIG. 1) as a calculator, stimulus representation 160 could include a representation of the differential equation and all of the necessary parameters. In this case, stimulus interpretation module 222 could identify the differential equation and generate a data set that defines the differential equation in the desired format of mathematical computation software used by remote computing device 110.

Likewise, to minimize the data transfer between remote computing device 110 and consumer product 120, stimulus representation 160 can include encoded/compressed data. In this case, stimulus interpretation module 222 can decode/decompress the encoded/compressed data to determine stimulus 150 (FIG. 1) received by consumer product 120. For example, consumer product 120 could include an animated toy dog that is capable of receiving four different stimuli 150: a user petting the toy dog; a user speaking a command; a contact stimulus resulting from the toy dog walking into an object; and a shutoff timer thrown after a defined inactivity period. In this case, stimulus representation 160 can include a two-bit datum representative of one of the four stimuli 150 received by the toy dog, as well as an identity value indicating the identity of the toy dog. When transmitted to remote computing device 110, stimulus interpretation module 222 can use a look-up table associated with the identity value of the toy dog to identify the stimulus 150 received by the toy dog using the two-bit datum. Stimulus interpretation module 222 then provides its interpretation of stimulus representation 160 to response modeling module 224.

Response modeling module 224, in at least one embodiment, generates a response to stimulus representation 160 based on, at least in part, the architecture or format of consumer product 120 (FIG. 1). Using the previous toy dog example, the toy dog's behavior could be based on a complex relationship between user's interaction with the toy dog, the environment of the toy dog, and the like. In this case, product modeling module 224 can include an algorithm to model the toy dog's behavior based on received stimuli 150 (FIG. 1). For instance, the algorithm could determine the type of bark emitted by the toy dog based on the number of “pettings” the toy dog receives from the user in a given time period. Likewise, the algorithm could allow the toy dog to exhibit a primitive form of artificial intelligence by using user input to train the actions of the toy dog. For example, the toy dog could receive stimulus 150 (FIG. 1) representing a voice command from the user. The toy dog could then send stimulus representation 160 representing the voice command to remote computing device 110. Stimulus interpretation module 222 could determine that the voice command is not in a locally accessible voice command database (one embodiment of data storage 230). In this case, stimulus interpretation module 222 could request a definition of the voice command using a larger voice command database stored on data provider 140 (FIG. 1). Stimulus interpretation module 222 can supply the resulting definition of the heretofore unknown voice command to response modeling module 224, as well as store it in its own locally accessible voice command database. Response modeling module 224 can then take the definition for the voice command and determine the appropriate action to be performed by the toy dog. For example, if the voice command included the term “speak”, then response modeling module 224 could form a response that includes instructions to cause a speaker on the toy dog to emit a barking sound. Additionally, the “speak” voice command could then be stored by stimulus interpretation module 222 for later retrieval, increasing the “intelligence” of the toy dog.

In at least one embodiment, response modeling module 224 manages a log of stimuli 150 (FIG. 1) received by consumer product 120. Using the toy dog example, a log of the number of times the toy dog encounters a wall can be logged by response modeling module 224. In this case, response modeling module 224 can use the logged stimuli 150 to determine an appropriate response. For example, the toy dog can include two contact sensors, one in front and one in back of the toy dog, and a stimulus is received by the toy dog by the front sensor when the toy dog attempts to move forward followed by a stimulus received by the back sensor when the toy dog subsequently attempts to move backward. Response modeling module 224 can determine, based on the log of these received stimuli, that the toy dog can move neither forward nor back, so response modeling module 224 can generate a set of operating instructions (response representation 170) that direct the toy dog to turn to one side and proceed forward.

Response format module 226, in one embodiment, receives the response generated by response modeling module 224 and formats the response in accordance with the design of consumer product 120 (FIG. 1) to generate response representation 170. For example, response format module 226 can encode the data into a format executable by a processor of remote computing device, it can encrypt the data to prevent access by a third party, and the like. Response representation 170, in one embodiment, is then transmitted to consumer product 120 using host interface 115.

As discussed previously, in at least one embodiment, response generation module 220 requires additional data in order to form a response to stimulus representation 160. Using the previous example of a voice command (stimulus 150, FIG. 1) received by a toy dog (consumer product 120), the definition or action to be executed by the toy dog can be searched for in data storage 230. Data storage 230 can include a database, file, or directory stored on a locally accessible storage device, such as a hard disk, a compact disc (CD), in memory, and the like. For example, data storage 230 can include a database of voice commands stored on the hard drive of a personal computer. The data (local data 235) can be retrieved from data storage 230 and provided to response generation module 220 using data processing module 210.

Likewise, in at least one embodiment, the additional data can be retrieved from data provider 140 (FIG. 1) over network 130 (FIG. 1) using network module 240. Network module 240 can include a network interface, such as a modem, an Ethernet card, a wireless modem, and the like. Using the previous toy dog example, data provider 140 could include a voice command processing system with a data server connected to the Internet that is more extensive than a voice command processing system and the database stored in data storage 230. Accordingly, response generation module 220 could request a definition of an unknown voice command from data provider 140 via network module 240. The request data (external data 180) can then be provided to response generation module 220 for generation of response representation 170.

In at least one embodiment, remote computing device 110 is capable of assisting the programming or upgrading of consumer product 120 (FIG. 1). For example, consumer product 120 could utilize a software-based operating system. In this case, remote computing device 110 can retrieve the latest version of the operating system or operating instructions used by consumer product 120 from data storage 230 or from data provider 140 (FIG. 1) as local data 235 or external data 180, respectively. The set of operating instructions or upgrade data can then be transmitted to consumer product 120 as upgrade data 250 using host interface 115.

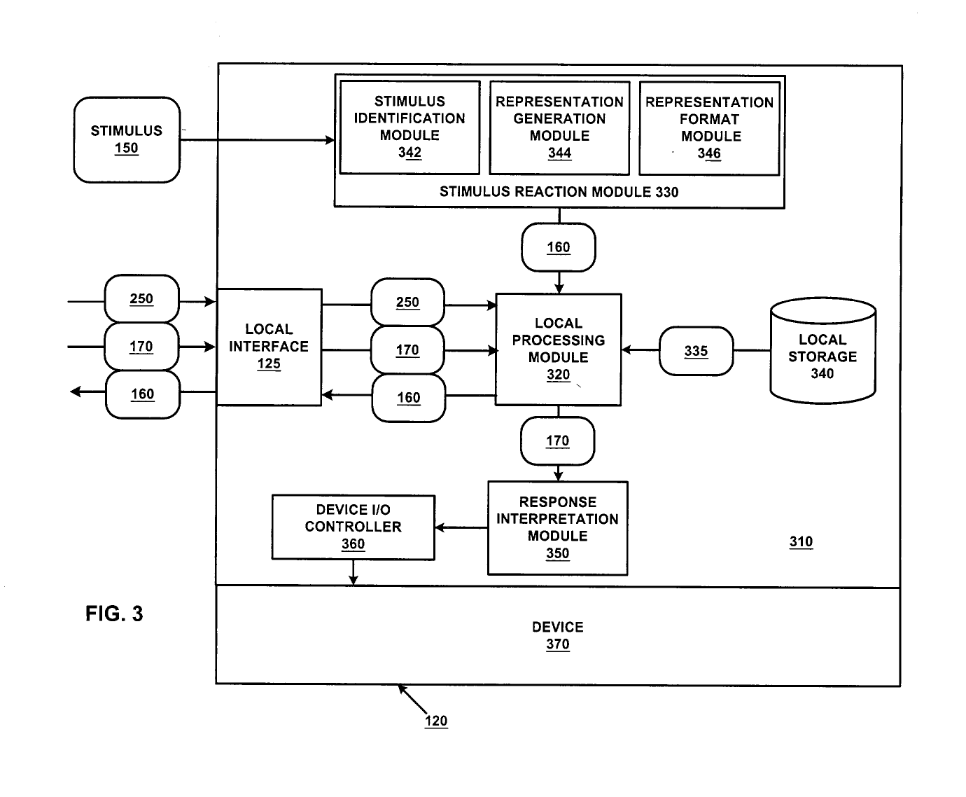

Referring next to FIG. 3, consumer product 120 is illustrated in greater detail according to at least one embodiment of the present disclosure. As discussed previously, in at least one embodiment, consumer product 120 receives stimulus 150, generates stimulus representation 160 based on stimulus 150, and transmits stimulus representation 160 to remote computing device 110 (FIG. 1). Remote computing device 110 can generate a response to stimulus representation 160 and transmit it to consumer product 120 as response representation 170. Consumer product 120, in at least one embodiment, then implements or performs the response defined by response representation 170.

Consumer product 120 includes mobile unit 310 and device 370. Mobil unit 310, in one embodiment, includes the data processing center, or “brains”, of consumer product 120 while device 370 includes the apparatus, or “body”, of consumer product 120. For example, consumer product 120 can include an animated toy where mobile unit 310 includes the processing center and sensors of the animated toy while device 370 includes one or more motion apparatuses controlled by mobile unit 310. Mobile unit 310 includes local processing module 320, stimulus reaction module 330, local storage 340, response interpretation module 350, and device input/output (I/O) controller 360.

In at least one embodiment, stimulus 150 is received by consumer product 120. As discussed previously, stimulus 150 can include an external stimulus, such as an environmental stimulus, or an internal stimulus, such as a timer or interrupt from device 370. In one embodiment, stimulus 150 is received by stimulus reaction module 330. Stimulus reaction module 330 includes stimulus identification module 342, representation generation module 344, and representation format module 346. Stimulus reaction module 330 can include a set of executable instructions to be performed by local processing module 320, a hardware component, such as an ASIC or PLD, or a combination thereof. Stimulus identification module 342, in one embodiment, identifies or determines the properties associated with stimulus 150. For example, consumer product 120 can include a television and stimulus 150 can include the pressing of a button on a remote control associated with the television. In this case, stimulus identification module 342 could identify the stimulus based on the pattern of the infrared light signal sent by the remote control. After identifying the remote control command stimulus, stimulus identification module 342 can determine certain parameters associated with the command, such as television volume, video input device, and the like. In at least one embodiment, stimulus reaction module 330 includes an environmental sensor, such as a motion sensor, light sensor, or contact switch, to receive stimulus 150. For example, stimulus identification module 342 can include a heat sensor that detects and measures abnormal heat sources. In this case, stimulus identification module 342 could use the heat sensor to determine the temperature of the heat source and include this temperature as part of stimulus representation 160.

Representation generation module 344, in one embodiment, receives stimulus 150 and its associated parameters determined by stimulus identification module 342 and uses this information to generate stimulus representation 160. Stimulus representation 160, in at least one embodiment, is generated to include a desired action or computational task resulting from stimulus 150 and any information or parameters available to consumer product 120 that could be used to generate the desired action or computational task. Using the previous television example, representation generation module 344 could include a number of speakers associated with the television, as well as the desired computational task (i.e. determination of the balance and fade of the speakers that results in a balance audio output) into a data structure as part of stimulus representation 160.

In at least one embodiment, representation generation module 344 determines the availability of a desired response to stimulus 150. The availability of the desired response can be determined in a number of ways. One way includes determining if an algorithm or process is locally available to consumer product 120 that can handle stimulus 150. For example, local storage 340 could store a number of executable software programs that handle different stimuli 150. In this case, representation generation module 344 can check for the availability of a software program to handle stimulus 150. If the software program is present, representation generation module 344 can direct local processing module 320 to execute the software program to handle stimulus 150. As a result of stimulus 150 being handled locally, consumer product 120 does not need to transmit stimulus representation 160 to remote computing device 110. Alternatively, in at least one embodiment, the availability of a desired response to stimulus 150 is determined based on the capability of consumer product 120 to process stimulus 150. For example, if the processing of stimulus 150 were to consume an unacceptable amount of power or consume to many processor cycles, then representation generation module 344 can assume that a response is unavailable and transmit stimulus representation 160 to remote computing device 110 to have remote computing device 110 generate a response. Accordingly, representation generation module 344 can balance the workload or power consumption of consumer product 120 by passing of computational tasks arising from stimuli 150 that require to many resources of consumer product 120.

In at least one embodiment, consumer product 120 includes local storage 340 having a limited storage capacity. Local storage 340 can include random access memory (RAM), read only memory (ROM), cache, a removable storage medium such as a floppy disc, and the like. Local storage 340, in one embodiment, is used to provide stimulus data 335 to stimulus reaction module 330 for use in generating stimulus representation 160. For example, local storage 340 can include a lookup table of values representative of various stimuli 150 that can be received by consumer product 120, and representation generation module 344 can use these values to generate stimulus representation 160.

Representation format module 346, in one embodiment, formats stimulus representation 160 into a format appropriate for transmission to remote computing device 110 (FIG. 1). For example, representation format module 346 could add error detection bits, headers, and the like. Stimulus representation 160, in one embodiment, is then transmitted to remote computing device 110 using local interface 125. Local interface 125 can include a wireless interface, such as an RF transceiver, or a physical interface, such as a universal serial bus.

As discussed previously, remote computing device 110 (FIG. 1), in one embodiment, receives stimulus representation 160 and generates a response, represented by response representation 170, and transmits response representation 170 to consumer product 120. Recall that stimulus representation 160 can include data describing stimulus 150 and data describing a desired action or computational task and response representation 170 can include data representing the desired action or results of the computational task. For example, consumer product 120 can include a calculator used to perform simple mathematical calculations as directed by a user. However, when the user enters a mathematical calculation (i.e. stimulus 150) that is too complex for the calculator to handle, the calculator transmits the mathematical calculation and any associated parameters to remote computing device 110 for processing. In this case, response representation 170 could include data representing the solution to the mathematical calculation and/or image data representing a plot of the solution.

Response representation 170, in one embodiment, is received from remote computing device 110 (FIG. 1) by local interface 125. For example, local interface 125 and host interface 115 (FIG. 1) can include RF transceivers used to transmit data between consumer product 120 and remote computing device 110. Response interpretation module 350, in one embodiment, interprets response representation 170 to determine or identify the response indicated by response representation 170. For example, response representation 170 can include instructions to direct the operation of device 370, such as to display a certain image on a display (one embodiment of device 370) or to direct the operation of a motor servo of a mechanical apparatus (another embodiment of device 370). Likewise, response representation 170 can include data that is to be processed by response interpretation module 350. Response interpretation module 350 can include a set of executable instructions executed by local processing module 320, one or more hardware components such as an ASIC, or a combination thereof. Any output to device 370 or input from device 370, in one embodiment, is managed by device I/O controller 360. Device I/O controller 360 can support a variety of I/O device such as an analog-to-digital (A/D) converter, a digital-to-analog (D/A) converter, digital I/O port, peripheral serial interface (PSI), and the like.

Device 370, in at least one embodiment, performs an action as directed by an interpretation of response representation 170 by response interpretation module 350. For example, device 370 can include a display device, and response representation 170 can include a compressed image file that is decompressed by response interpretation module 350 and transmitted to the display device for display as bitmap data. Likewise, device 370 can include a printing device used to print an outcome dictated by response representation 170. Device 370 can also include a mechanical assembly, such as a servo assembly that controls the movement of the appendages of a toy robot. In this case, response representation 170 can include instructions that direct the motion of the appendages in response to stimulus 150. Although a variety of embodiments of device 370 have been illustrated herein, other embodiments of device 370 can be implemented without departing from the spirit or the scope of the present disclosure.

In at least one embodiment, local processing module 320 manages one or more functions of mobile unit 310. For example, local processing module 320 can manage the transfer of response representation 170 between local interface 170 and response interpretation 350, the transfer of stimulus data 335 from local storage 340 to stimulus reaction module 330, and the like. Additionally, stimulus reaction module 330 and/or response interpretation module 350 are implemented as sets of operating instructions executed by local processing module 320. Local processing module 320 can include one of a variety of data processors, such as a microcontroller, a microprocessor, a programmable logic device, an ASIC, and the like. In at least one embodiment, the processing capabilities of local processing module 320 is relatively limited with respect to the computing tasks to be performed resulting from stimuli 150. In order to save time and/or power, in at least one embodiment, the computing task is transferred to remote computing device 110 as stimulus representation 160, where data processing module 310 (FIG. 1) of remote computing device 110 has superior processing capabilities respective to local processing module 320. Accordingly, the computing task can be performed more quickly by remote computing device 110, thereby saving time in performing the computing task.

Recall that, in one embodiment, remote computing device 110 (FIG. 1) is capable of upgrading or reprogramming consumer product 120 by transmitting upgrade data 250 to consumer product 120 via local interface 125. In this case, upgrade data 250 can include a set of operating instructions utilized by response interpretation module 350 to augment or replace an operating system used by local processing module 320. Similarly, local processing module 320 can include a programmable logic device, such as a field programmable gate array, and upgrade data 250 can include programming data file used by response interpretation module 350 to program the programmable logic device.

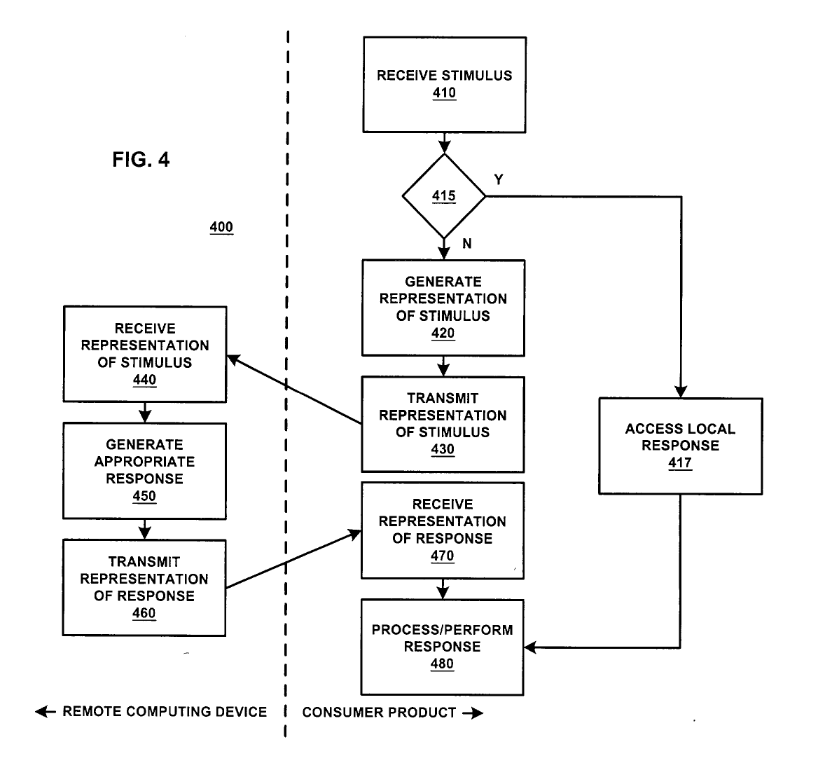

Referring to FIG. 4, a method for distributed computing using distributed system 100 (FIG. 1) is illustrated according to at least one embodiment of the present disclosure. Distributed method 400 initiates with step 410, wherein consumer product 120 (FIG. 1) receives stimulus 150 (FIG. 1). Recall that stimulus 150 can include an external stimulus, such as the manipulation of a button or the entry of data by a user or an environmental stimulus, or an internal stimulus, such as the termination of a timer or an interrupt thrown by device 370 (FIG. 3). In at least one embodiment, stimulus 150 is interpreted by stimulus identification module 342 (FIG. 3) to determine the factors involved with stimulus 150. For example, stimulus 150 can include the storage of a data value in a particular register associated with local processing module 320 (FIG. 3). In this case, stimulus identification module 342 can interpret stimulus 150 by decoding the data value and retrieving data from other registers associated with the data value.

In step 415, consumer product 120 (FIG. 1), in one embodiment, determines if a local response is available to the received stimulus 150 (FIG. 1). For example, consumer product 120 can include a toy dog that is capable of responding to a variety of voice commands (stimuli 150). When the toy dog receives a voice command, the toy dog can search for a local response to the voice command. For example, stimulus identification module 342 (FIG. 3) can search local storage 340 for a set of operating instructions associated with the voice command. If a local response is found to the received stimulus, then the response is prepared for execution in step 417. Using the toy dog example, in step 417, the set of operating instructions in local storage 340 associated with the voice command can be loaded into memory for subsequent execution by local processing module 320 (FIG. 3) in step 480.

In the event that a local response to stimulus 150 (FIG. 1) is not found and/or is not feasible to implement, consumer product 120 (FIG. 1) generates stimulus representation 160 (FIG. 1) based on stimulus 150 in step 420. In at least one embodiment, stimulus representation 160 includes data that describe stimulus 150 as well as a desired computational task or action. For example, consumer product 120 can include a handheld calculator and stimulus 150 can include an equation input by a user. In this case, response generation module 344 (FIG. 3) can receive stimulus 150 and any associated parameters from stimulus identification module 342 (FIG. 3) and determine the desired action or computational task (i.e. computing the results of a solution to the equation). The a representation of stimulus 150, any associated parameters, and the desired computational task or action, in one embodiment, is transmitted to remote computing device 110 (FIG. 1) in step 430. In at least one embodiment, a wireless communications interface is used to transfer data between consumer product 120 and remote computing device 110. For example, host interface 115 (FIG. 1) and local interface 125 (FIG. 1) can include RF transceivers.

Additionally, in at least one embodiment, the availability of a response local to consumer product 120 (FIG. 1) is determined in step 420. As discussed previously, consumer product 120 can determine, in one embodiment, its capability of performing a computational task associated with stimulus 150 (FIG. 1). In the event that the computational task would require too many resources of consumer product 120, the computational task could be transmitted to remote computing device 110 (FIG. 1) for processing as stimulus representation 160. However, if the computational task can be performed by consumer product 120 without drawing too much power or requiring too much processor effort, then consumer product 120 can handle the computational task and forgo the remaining steps of distribution method 400.

In step 440, stimulus representation 160 (FIG. 1) is received or retrieved by remote computing device 110 (FIG. 1). In at least one embodiment, stimulus interpretation module 222 (FIG. 2) or remote computing device 110 interprets stimulus representation 160 to determine the desired action or computational task indicated by stimulus representation 160. For example, stimulus representation 160 can include an encoded data value that indicates the type of stimulus 150 (FIG. 1) received by consumer product 120 (FIG. 1). In this case, stimulus interpretation module 222 could include a lookup table that includes stimuli 150 corresponding to a plurality of encoded data values.

In step 450, remote computing device 110 (FIG. 1) generates a response based on a computational task or action indicated by stimulus representation 160 (FIG. 1). For example, consumer product 120 can include a toy robot that receives a voice command (stimulus 150, FIG. 1) from a user. The voice command can be transmitted to remote computing device 110 for interpretation. In this case, response modeling module 224 (FIG. 2) can determine a series of motions to be performed by the toy robot that represent the desired results of the user's voice command. In at least one embodiment, step 450 also includes the step of retrieving external data 180 (FIG. 1) from data provider 140 (FIG. 1) over network 130 (FIG. 1). Using the previous toy robot example, stimulus interpretation module 222 (FIG. 2) could request a definition of the voice command issued by the user from a voice command processing system and database (data provider 140) connected to the Internet (network 130). This definition can then be passed to response modeling module 224 for generation of the desired response.

In at least one embodiment, the desired response is generated based on user input. For example, consumer product 120 can include a stereo and stimulus 150 can include an internal timer going off. In this case, the user could specify certain settings, such as the station and volume, of the stereo using a software program on a personal computer (remote computing device 110, FIG. 1). The stereo could then send a request for these settings as stimulus representation 160 (FIG. 1) and receive the settings as response representation 170 (FIG. 1). The desired response, in one embodiment, is transmitted to consumer product 120 as response representation 170 in step 460.

In step 470, response representation 170 (FIG. 1) is received or retrieved by consumer product 120 (FIG. 1). In step 480, the response to stimulus 150 (FIG. 1) is performed. If a local response was located in step 415, then the local response can be the response to be performed. Otherwise, the response represented by response representation 170 transmitted from remote computing device 110 (FIG. 1) is processed or performed by consumer product 120. For example, consumer product 120 can include a DVD player and device 370 (FIG. 3) can include a television. In this case, response representation 170 can include a summary or review of a movie recorded on a DVD being played by the DVD player. Using another example, consumer product 120 can include a toy robot and device 370 can include servo assembly that controls the appendages of the toy robot. In this case, response representation 170 can include instructions that direct the motion of the servo assembly, and the instructions are executed by response interpretation module 350 and the servo data or signal is transmitted to device 370 using device I/O controller 360 (FIG. 3).

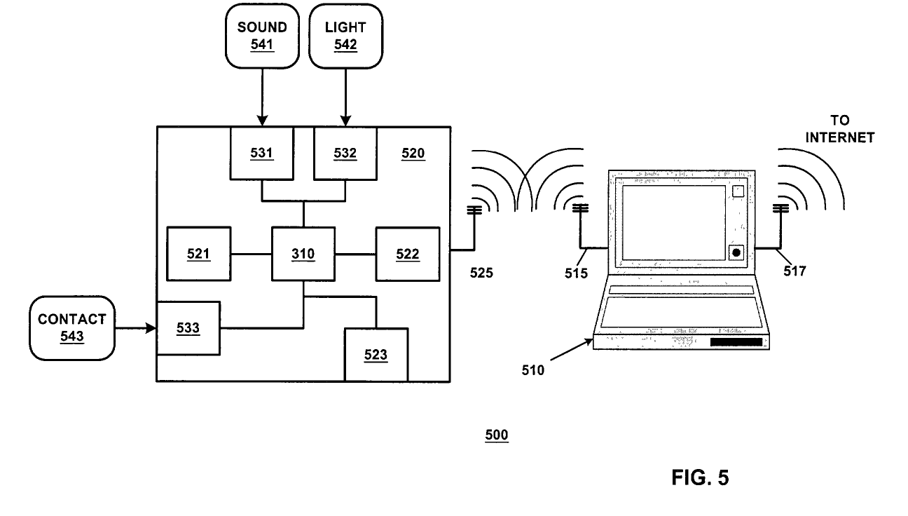

Referring next to FIG. 5, an exemplary implementation of distributed system 100 (FIG. 1) is illustrated according to at least one embodiment of the present disclosure. In at least one embodiment, distributed system 100 is implemented to benefit from the comparative advantages of remote computing device 110 (FIG. 1) and consumer product 120 (FIG. 1). For example, a personal computer (remote computing device 110) may have a relatively powerful processor, nearly unlimited power supply and/or high-speed communication system, but it is costly to implement in a consumer product, as well as ungainly. On the other hand, although an animated toy (consumer product 120) may have a relatively weak processor, a limited power supply and/or slow communication system, it is generally inexpensive to manufacture. Accordingly, as discussed in the present disclosure, the animated toy can make use of the personal computer's processing capabilities, power, and communications to generate a response to a stimulus received by the animated toy, while minimizing the cost of manufacture. Animation system 500, one embodiment of distributed system 100 (FIG. 1), is one example of the advantages of the present disclosure. Animation system 500, in this example, is used to direct the actions of an animated toy.

Animation system 500 includes personal computer 510 (one embodiment of remote computing device 110, FIG. 1) and animated toy dog 520 (one embodiment of consumer product 120, FIG. 1). Personal computer 510 can include a personal computer, a notebook computer, a laptop computer, a workstation, and the like. Animated toy dog 520 includes mobile unit 310, motion assemblies 521-523, and sensors 531-533. In at least one embodiment, animated toy 520 and personal computer 510 communicate using local RF transceiver 525 and host RF transceiver 515, respectively.

Animated toy dog 520, in one embodiment, includes a limited set of operating instructions used by mobile unit 310 to direct the operation of animated toy 520, such as instructions to direct the movement of mouth motion assembly 521, tail motion assembly 522, and legs motion assembly 523. For example, the set of instructions could direct legs motion assembly 523 to move in a manner that causes animated toy dog 520 to walk forward and direct tail motion assembly 522 to wag a tail of animated toy dog 520. Animated toy dog 520, in one embodiment, operates using this set of operating instructions until a stimulus (stimulus 150, FIG. 1) is received. For example, animated toy dog 520 can include a variety of sensors to detect environmental stimuli, such as sound sensor 531 to detect sound stimuli 541, light sensor 532 to detect light stimuli 542, and contact sensor 533 to detect contact with objects in the path of animated toy dog 520 (contact stimuli 543). Similarly, animated toy dog 520 can respond to internally generated stimuli, such as a timer or a counter. When a stimulus is received, animated toy dog 520, in one embodiment, determines if a local response is available and/or feasible. If so, animated toy dog 520 performs the locally available response. If not, animated toy dog 520 can generate stimulus representation 160 (FIG. 1) and transmit it to personal computer 510. Personal computer 510 can then determine and/or generate the desired response to stimulus representation 160 and send this response back to animated toy dog 520 as response representation 170. For example, response representation 170 can include a different set of operating instructions to replace the set of operating instructions used by animated toy dog 520. Personal computer 510, in one embodiment, can user network interface 517 to communicate to data provider 140 (FIG. 1) over the Internet to obtain additional data to be used to generate response representation 170. Various examples of the operation of animation system 500 are discussed subsequently.

One example includes animated toy dog 520 receiving sound stimulus 541 using sound sensor 531. In this case, sound stimulus 541 can include a user vocalizing a command, such as “sit”. Animated toy dog 520, in this case, could determine if mobile unit 310 includes operating instructions associated with the command “sit”. If so, then animated toy dog 520 can perform the instructions. If not, then animated toy dog 520 can send data representing the sound of the user saying the word “sit” (sound stimulus 541) to personal computer 510 as stimulus representation 160 (FIG. 1). Personal computer 510 can then analyze stimulus representation 160 to determine if it has operating instructions (the response) associated with the command “sit”. If the operating instructions are locally available, personal computer 510 can send the operating instructions to animated toy dog 520 as response representation 170. Otherwise, personal computer 510 can obtain the operating instructions associated with the command “sit” from data provider 140 (FIG. 1) using network interface 517. Animated toy dog 520, upon receiving response representation 170, can replace or augment its set of operating instructions with the operating instructions represented by response representation 170 and then perform the operating instructions to cause leg motion assembly 523 to move in manner such that animated toy dog 520 “sits”.

Another example includes animated toy dog 520 receiving light stimulus 542 using light sensor 531. In this case, light stimulus 542 can include an infrared light signal emitted from a remote control operated by a user, where the signal is to direct animated toy dog 520 to “bark”. Animated toy dog 520 can analyze the infrared signal's pattern to identify the action associated with light stimulus 542. If the “bark” action is available to animated toy dog 520, animated toy dog 520 can perform the action using mouth motion assembly 521. Otherwise, animated toy dog 520 can send data representative of the infrared signal to personal computer 510 as stimulus representation 160 (FIG. 1). Personal computer 510 can then send operating instructions to direct animated toy dog 520 to perform the “bark” action as response representation 170 (FIG. 1). For example, personal computer 510 can include a dictionary stored in data storage 230 (FIG. 2) that defines the term “bark” and personal computer 510 can generate the operating instructions based on this definition.

In another example, animated toy dog 520 receives contact stimulus 543 using contact sensor 533 when animated toy dog 520 bumps into an object. In this case, mobile unit 310 includes a counter that logs the number of contact stimuli 543 received by animated toy dog 520 within a certain time period. Once a certain number of contact stimuli 543 has been reached, mobile unit 310 assumes that animated toy dog 520 is stuck and sends a signal to personal computer 510 indicating that animated toy dog 520 is stuck. Personal computer 510, or a user of personal computer 510, can then determine a response intended to get animated toy dog 520 unstuck. For example, personal computer 510 can display a map of the locations where animated toy dog 510 received contact stimuli 543 and a user can analyze this map to determine a path to get animated toy dog 520 unstuck. In this case, operating instructions that direct animated toy dog 520 to move in the indicated path are sent to animated toy dog 520 as response representation 170 (FIG. 1). As illustrated by the previous examples, animated toy dog 520 can perform actions that exceed its limited set of operating instructions by using personal computer 510 to generate and/or update sets of operating instructions based on stimuli received by animated toy dog 520.

Although consumer product 120 has been discussed previously as an entertainment-based or home-electronics consumer product, consumer product 120 can include consumer products in other various categories. For example, consumer product 120 can include a handheld computing device, such as a personal digital assistant or handheld global positioning system (GPS). Likewise, consumer product 120 can include a building security system connected via a wireless interface to a network of workstations.

The various functions and components in the present application may be implemented using an information handling machine such as a data processor, or a plurality of processing devices. Such a data processor may be a microprocessor, microcontroller, microcomputer, digital signal processor, state machine, logic circuitry, and/or any device that manipulates digital information based on operational instruction, or in a predefined manner. Generally, the various functions, and systems represented by block diagrams are readily implemented by one of ordinary skill in the art using one or more of the implementation techniques listed herein. When a data processor for issuing instructions is used, the instruction may be stored in memory. Such a memory may be a single memory device or a plurality of memory devices. Such a memory device may be read-only memory device, random access memory device, magnetic tape memory, floppy disk memory, hard drive memory, external tape, and/or any device that stores digital information. Note that when the data processor implements one or more of its functions via a state machine or logic circuitry, the memory storing the corresponding instructions may be embedded within the circuitry that includes a state machine and/or logic circuitry, or it may be unnecessary because the function is performed using combinational logic. Such an information handling machine may be a system, or part of a system, such as a computer, a personal digital assistant (PDA), a hand held computing device, a cable set-top box, an Internet capable device, such as a cellular phone, and the like.

One of the implementations of the invention is as sets of computer readable instructions resident in the random access memory of one or more processing systems configured generally as described in FIGS. 1-5. Until required by the processing system, the set of instructions may be stored in another computer readable memory, for example, in a hard disk drive or in a removable memory such as an optical disk for eventual use in a compact disc (CD) drive or digital versatile disc (DVD) drive or a floppy disk for eventual use in a floppy disk drive. Further, the set of instructions can be stored in the memory of another processing system and transmitted over a local area network or a wide area network, such as the Internet, where the transmitted signal could be a signal propagated through a medium such as an ISDN line, or the signal may be propagated through an air medium and received by a local satellite to be transferred to the processing system. Such a signal may be a composite signal comprising a carrier signal, and contained within the carrier signal is the desired information containing at least one computer program instruction implementing the invention, and may be downloaded as such when desired by the viewer. One skilled in the art would appreciate that the physical storage and/or transfer of the sets of instructions physically changes the medium upon which it is stored electrically, magnetically, or chemically so that the medium carries computer readable information. The preceding detailed description is, therefore, not to be taken in a limiting sense, and the scope of the present disclosure is defined only by the appended claims.

In the preceding detailed description of the figures, reference has been made to the accompanying drawings which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present disclosure is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present disclosure is defined only by the appended claims.

What is claimed is:

1. A method comprising the steps of:
receiving at a remote computing device a representation of a first stimulus from a consumer product, wherein the representation of the first stimulus is generated by the consumer product in response to the first stimulus, and the remote computing device is remote relative to the consumer product;
determining at the remote computing device a desired response based on the representation of the first stimulus; and
transmitting for reception by the consumer product a representation of the desired response.

2. The method as in claim 1, wherein the first stimulus includes a stimulus external to the consumer product.

3. The method as in claim 2, wherein the first stimulus includes an environmental stimulus.

4. The method as in claim 1, wherein the first stimulus includes a stimulus internal to the consumer product.

5. The method as in claim 1, wherein the representation of the first stimulus is used by the remote computing device to determine a computational task to be performed by the remote computing device, and where the desired response includes a results of a performance of the computational task

6. The method as in claim 1, wherein the step of transmitting the representation of the desired response includes transmitting the representation of the desired response using a wireless interface.

7. The method as in claim 6, wherein the wireless interface is selected from the group consisting of: a RF transceiver, a microwave transceiver, and an infrared transceiver.

8. The method as in claim 1, wherein the step of transmitting the representation of the desired response includes transmitting the representation of the desired response using a physical interface.

9. The method as in claim 8, wherein the physical interface is selected from the group consisting of: a RS-232 interface, a parallel interface, and a universal serial bus.

10. The method as in claim 1, further including the step of transmitting for reception by the consumer product a set of operating instructions.

11. The method as in claim 10, wherein the set of operating instructions is to facilitate the upgrade of an operating system used by the consumer product.

12. The method as in claim 1, wherein the desired response is determined based additionally on a representation of a second stimulus received from the consumer product previous to the representation of the first stimulus.

13. The method as in claim 1, wherein the desired response is determined based additionally on a user input at the remote computing device.

14. A method comprising the steps of:
receiving a first stimulus at a consumer product;
transmitting for reception by a remote computing device a representation of the first stimulus, where the remote computing device is remote relative to the consumer product; and
receiving from the remote computing device a representation of a desired response based on the representation of the first stimulus.

15. The method as in claim 14, wherein the first stimulus includes a stimulus external to the consumer product.

16. The method as in claim 15, wherein the stimulus external to the consumer product includes an environmental stimulus.

17. The method as in claim 14, wherein the first stimulus includes a stimulus internal to the consumer product.

18. The method as in claim 14, wherein the representation of the first stimulus is used by the remote computing device to determine a computational task to be performed by the remote computing device.

19. The method as in claim 18, wherein the representation of desired response includes a result of a performance of the computational task

20. The method as in claim 14, wherein the step of transmitting the representation of the first stimulus includes transmitting the representation of the first stimulus using a wireless interface.

21. The method as in claim 20, wherein the wireless interface is selected from the group consisting of: a RF transceiver, a microwave transceiver, and an infrared transceiver.

22. The method as in claim 14, wherein the step of transmitting the representation of the first stimulus includes transmitting the representation of the first stimulus using a physical interface.

23. The method as in claim 22, wherein the physical interface is selected from the group consisting of: a RS-232 interface, a parallel interface, and a universal serial bus.

24. The method as in claim 14, further including the step of receiving from the remote computing device a set of operating instructions.

25. The method as in claim 24, wherein the set of operating instructions is to facilitate the upgrade of an operating system used by the consumer product.

26. The method as in claim 14, wherein the desired response is determined based additionally on a representation of a second stimulus received by the consumer product previous to the representation of the first stimulus.

27. The method as in claim 14, wherein the desired response is determined based additionally on a user input at the remote computing device.

28. The method as in claim 14, wherein the step of transmitting the representation of the first stimulus includes selecting the remote computing device from a plurality of remote computing devices.

29. The method as in claim 14, further including the step of processing the representation of the desired response.

30. The method as in claim 29, wherein the representation of the desired response includes an action to be performed by the consumer product, and the step of processing includes performing the action.

31. A method comprising the steps of:
receiving a first stimulus at a consumer product;
determining at the consumer product an availability of a desired response to be performed based on the first stimulus;
transmitting a representation of the first stimulus to a remote computing device when the desired response is determined to be unavailable, where the remote computing device is remote relative to the consumer product; and
receiving a representation of the desired response from the remote computing device as a result of the transmission of the representation of the first stimulus.

32. The method as in claim 31, wherein the first stimulus includes a stimulus external to the consumer product.

33. The method as in claim 32, wherein the stimulus external to the consumer product includes an environmental stimulus.

34. The method as in claim 31, wherein the first stimulus includes a stimulus internal to the consumer product.

35. The method as in claim 31, wherein the desired response includes a result of a performance of a computational task.

36. The method as inc claim 35, wherein the step of determining the availability of the desired response includes determining the capability of the consumer product to perform the computational task.

37. The method as in claim 31, wherein the representation of the first stimulus is used by the remote computing device to determine a computational task to be performed by the remote computing device.

38. The method as in claim 31, wherein the step of transmitting the representation of the first stimulus includes transmitting the representation of the first stimulus using a wireless interface.

39. The method as in claim 38, wherein the wireless interface is selected from the group consisting of: a RF transceiver, a microwave transceiver, and an infrared transceiver.

40. The method as in claim 31, wherein the step of transmitting the representation of the first stimulus includes transmitting the representation of the first stimulus using a physical interface.

41. The method as in claim 40, wherein the physical interface is selected from the group consisting of: a RS-232 interface, a parallel interface, and a universal serial bus.

42. The method as in claim 31, further including the step of receiving from the remote computing device a set of operating instructions.

43. The method as in claim 42, wherein the set of operating instructions is to facilitate the upgrade of an operating system used by the consumer product.

44. The method as in claim 31, wherein the desired response is determined by the remote computing device based additionally on a representation of a second stimulus received from the consumer product previous to the representation of the first stimulus.

45. The method as in claim 31, wherein the desired response is determined by the remote computing device based additionally on a user input at the remote computing device.

46. The method as in claim 31, wherein the step of transmitting the representation of the first stimulus includes selecting the remote computing device from a plurality of remote computing devices.

47. The method as in claim 31, further including the step of processing the representation of the desired response.

48. The method as in claim 47, wherein the representation of the desired response includes an action to be performed by the consumer product, and the step of processing includes performing the action.

49. A method comprising the steps of:
receiving at a remote computing device a representation of a first stimulus from an animated consumer product, where the representation of the first stimulus is generated by the animated consumer product in response to the first stimulus; and
transmitting for reception by the animated consumer product a representation of a desired response based on the representation of the first stimulus.

50. The method as in claim 49, wherein the first stimulus includes a stimulus external to the animated consumer product.

51. The method as in claim 50, wherein the stimulus external to the animated consumer product includes an environmental stimulus.

52. The method as in claim 49, wherein the first stimulus includes a stimulus internal to the animated consumer product.

53. The method as in claim 49, wherein the desired response includes a result of a performance of a computational task.

54. The method as in claim 49, wherein the representation of the first stimulus is used by the remote computing device to determine a computational task to be performed by the remote computing device.

55. The method as in claim 49, wherein the step of transmitting the representation of the first stimulus includes transmitting the representation of the first stimulus using a wireless interface.

56. The method as in claim 55, wherein the wireless interface is selected from the group consisting of: a RF transceiver, a microwave transceiver, and an infrared transceiver.

57. The method as in claim 49, wherein the step of transmitting the representation of the first stimulus includes transmitting the representation of the first stimulus using a physical interface.

58. The method as in claim 57, wherein the physical interface is selected from the group consisting of: a RS-232 interface, a parallel interface, and a universal serial bus.

59. The method as in claim 49, further including the step of transmitting to the animated consumer product a set of operating instructions.

60. The method as in claim 49, wherein the set of operating instructions is to facilitate the upgrade of an operating system used by the animated consumer product.

61. The method as in claim 49, wherein the desired response is determined based additionally on a representation of a second stimulus received from the animated consumer product previous to the representation of the first stimulus.

62. The method as in claim 49, wherein the desired response is determined based additionally on a user input at the remote computing device.

63. A consumer product comprising:
a stimulus reaction module to generate a representation of a stimulus;
an interface to transmit for reception by a remote computing device said representation of the stimulus;
an interface to receive from the remote computing device a representation of a desired response based on said representation of the stimulus; and
a processing module to process said representation of the desired response.

64. The consumer product as in claim 63, wherein the stimulus reaction module is coupled to a sensor that detects an external stimulus relative to the consumer product.

65. The consumer product as in claim 64, wherein the sensor is to detect an environmental stimulus.

66. The consumer product as in claim 63, wherein the stimulus reaction module is coupled to receive an internally generated stimulus.

67. The consumer product as in claim 63, wherein the desired response includes a result of a performance of a computational task.

68. The consumer product as in claim 67, wherein said representation of the stimulus is used by the remote computing device to determine the computational task to be performed by the remote computing device.

69. The consumer product as in claim 63, wherein said interface includes a wireless interface.

70. The consumer product as in claim 69, wherein said wireless interface is selected from the group consisting of: a RF transceiver, a microwave transceiver, and an infrared transceiver.

71. The consumer product as in claim 63, wherein said interface is selected from the group consisting of: a RS-232 interface, a parallel interface, and a universal serial bus.

72. The consumer product as in claim 63, wherein said stimulus reaction module includes a sensor to receive the stimulus.

73. The consumer product as in claim 63, wherein said stimulus reaction module is further to determine an availability of the desired response.

74. The consumer product as in claim 73, wherein said stimulus reaction module is to determine the availability of the desired response by determining a capability of said processing module to perform a computational task associated with the desired response.

75. A remote computing device comprising:
an interface to receive a representation of a first stimulus from a consumer product, where the representation of the first stimulus is generated by the consumer product in response to the first stimulus received by the consumer product;
a response generation module to generate a representation of a desired response based on the representation of the first stimulus; and
an interface to transmit for reception by the consumer product the representation of the desired response.

76. The remote computing device as in claim 75, wherein the first stimulus includes a stimulus external to the consumer product.

77. The remote computing device as in claim 76, wherein the first stimulus includes an environmental stimulus.

78. The remote computing device as in claim 75, wherein the first stimulus includes a stimulus internal to the consumer product.

79. The remote computing device as in claim 75, wherein the desired response includes a result of a performance of a computational task.

80. The remote computing device as in claim 79, wherein the representation of the first stimulus is used by the remote computing device to determine the computational task to be performed by said response generation module.

81. The remote computing device as in claim 75, wherein said interface includes a wireless interface.

82. The remote computing device as in claim 81, wherein said wireless interface is selected from the group consisting of: a RF transceiver, a microwave transceiver, and an infrared transceiver.

83. The remote computing device as in claim 75, wherein said interface is selected from the group consisting of: a RS-232 interface, a parallel interface, and a universal serial bus.

84. The method as in claim 75, wherein said response generation module is to generate said desired response based additionally on a representation of a second stimulus received from the consumer product by said interface previous to the representation of the first stimulus.

85. The method as in claim 75, wherein said response generation module is coupled to a user input device that receives user input, and where the desired response is determined based additionally on the user input.

86. A computer readable medium, said computer readable medium including instructions to manipulate a processor to:
receive at a remote computing device a representation of a first stimulus from a consumer product, wherein the representation of the first stimulus is generated by the consumer product in response to the first stimulus, and the remote computing device is remote relative to the animated consumer product;
determine at the remote computing device a first desired response based on the representation of the first stimulus; and
transmit for reception by the consumer product a representation of the first desired response.

87. The computer readable medium as in claim 86, wherein the first stimulus includes a stimulus external to the consumer product.

88. The computer readable medium as in claim 87, wherein the first stimulus includes an environmental stimulus.

89. The computer readable medium as in claim 86, wherein the first stimulus includes a stimulus internal to the consumer product.

90. The computer readable medium as in claim 86, wherein the representation of the first stimulus is used by the remote computing device to determine a computational task to be performed by the remote computing device, and where the desired response includes a results of a performance of the computational task

91. The computer readable medium as in claim 86, further including the instructions to manipulate said processor to retrieve an external data from a data provider, wherein the data provider is connected to the remote computing device using a network, and where the external data is used to determine the desired response.

92. The computer readable medium as in claim 86, wherein the instructions to manipulate said processor to transmit the representation of the desired response includes instructions to manipulate said processor to transmit the representation of the desired response using a wireless interface.

93. The computer readable medium as in claim 92, wherein the wireless interface is selected from the group consisting of: a RF transceiver, a microwave transceiver, and an infrared transceiver.

94. The computer readable medium as in claim 86, wherein the instructions to manipulate said processor to transmit the representation of the desired response includes instructions to manipulate said processor to transmit the representation of the desired response using a physical interface.

95. The computer readable medium as in claim 94, wherein the physical interface is selected from the group consisting of: a RS-232 interface, a parallel interface, and a universal serial bus.

96. The computer readable medium as in claim 86, further including instructions to manipulate said processor to transmit for reception by the consumer product a set of operating instructions.

97. The computer readable medium as in claim 96, wherein the set of operating instructions is to facilitate the upgrade of an operating system used by the consumer product.

98. The computer readable medium as in claim 86, wherein the desired response is determined based additionally on a representation of a second stimulus received from the consumer product previous to the representation of the first stimulus.

99. The computer readable medium as in claim 86, wherein the desired response is determined based additionally on a user input at the remote computing device.

100. A computer readable medium, said computer readable medium including instructions to manipulate a processor to:
receive a first stimulus at a consumer product;
transmit for reception by a remote computing device a representation of the first stimulus, where the remote computing device is remote relative to the consumer product; and
receive from the remote computing device a representation of a desired response based on the representation of the first stimulus.

101. The computer readable medium as in claim 100, wherein the first stimulus includes a stimulus external to the consumer product.

102. The computer readable medium as in claim 101, wherein the first stimulus includes an environmental stimulus.

103. The computer readable medium as in claim 100, wherein the first stimulus includes a stimulus internal to the consumer product.

104. The computer readable medium as in claim 100, wherein the representation of the first stimulus is used by the remote computing device to determine a computational task to be performed by the remote computing device.

105. The computer readable medium as in claim 104, wherein the representation of desired response includes a result of a performance of the computational task

106. The computer readable medium as in claim 100, wherein said instructions to manipulate said processor to transmit the representation of the first stimulus include instructions to manipulate said processor to transmit the representation of the first stimulus using a wireless interface.

107. The computer readable medium as in claim 106, wherein the wireless interface is selected from the group consisting of: a RF transceiver, a microwave transceiver, and an infrared transceiver.

108. The computer readable medium as in claim 100, wherein said instructions to manipulate said processor to transmit the representation of the first stimulus include instructions to manipulate said processor to transmit the representation of the first stimulus using a physical interface.

109. The computer readable medium as in claim 108, wherein the physical interface is selected from the group consisting of: a RS-232 interface, a parallel interface, and a universal serial bus.

110. The computer readable medium as in claim 100, further including instructions to manipulate said processor to receive from the remote computing device a set of operating instructions.

111. The computer readable medium as in claim 110, wherein the set of operating instructions is to facilitate the upgrade of an operating system used by the consumer product.

112. The computer readable medium as in claim 100, wherein the desired response is determined based additionally on a representation of a second stimulus received from the consumer product previous to the representation of the first stimulus.

113. The computer readable medium as in claim 100, wherein the desired response is determined based additionally on a user input at the remote computing device.

114. The computer readable medium as in claim 100, wherein said instructions to manipulate said processor to transmit the representation of the first stimulus include instructions to manipulate said processor to select the remote computing device from a plurality of remote computing devices.

115. The computer readable medium as in claim 100, further including instructions to manipulate said processor to process the representation of the desired response.

116. The computer readable medium as in claim 115, wherein the representation of the desired response includes a representation of an action to be performed by the consumer product, and said instructions to manipulate said processor to process the desired response include instructions to manipulate said processor to perform the action.
